(19) United States
(12) Patent Application Publication
(10) Pub. No.: US 2007/0131730 A1
(43) Pub. Date: Jun. 14, 2007

(54) DEVICE FOR SUPPORTING ITEMS ON A WHEELCHAIR

(75) Inventor: Mehdi Mirzale, Brentwood, TN (US)

Correspondence Address: HOLLAND & HART, LLP, P.O BOX 8749, DENVER, CO, 80201, US

(73) Assignee: Permobil AB, Timra (SE)

(21) Appl. No.: 11/539,746

(22) Filed: Oct. 9, 2006

(30) Foreign Application Priority Data
Oct. 18, 2005 (SE) 0502302-3

(51) Int. Cl. B60R 7/00

(52) U.S. Cl. 224/407

(57) ABSTRACT

A device for supporting items on a wheelchair that has a chassis (1) and a seat (2) which is movable in relation to the chassis is provided. The device comprises a part (33) that carries the item that can be connected to the seat. In order to enable there to be full freedom of movement for the seat and to avoid further loads on this or on its driving devices, the device comprises a load-bearing link mechanism (32) that is attached to the chassis and supports the item supporting part in such a way that it can move, for transference of load from the item supporting part to the chassis. The invention also relates to a wheelchair with such a device.

### TECHNICAL FIELD

The invention relates to a device for supporting items on a wheelchair. The invention also relates to a wheelchair with such a device.

The device can be used, for example, for carrying medical equipment and can be mounted on the wheelchair either when the wheelchair is manufactured or as a retrofit.

### BACKGROUND ART

For people in wheelchairs, it can sometimes be vital to be able to take various kinds of medical equipment with them while travelling in the wheelchair. Respirators are an example of such medical equipment that it is necessary to be able to take with them on the wheelchair. Mobile or portable respirators often comprise a casing that holds the respirator's active components and a separate battery.

Modern electric wheelchairs normally comprise a chassis and a seat that can move in relation to the chassis. The seat can comprise a lower seat frame, to which a cushion is attached, and a backrest. The seat can move in relation to the chassis by the whole seat being able to be raised or lowered, by the whole seat being able to be tilted in relation to the chassis and by the backrest being able to be tilted in relation to the seat frame and the chassis.

Among other things, in order to make it possible to use the wheelchair both indoors and outdoors, and in order to make it easy to have access to locations and to make it possible to transport the wheelchair in other vehicles, it is desirable for the wheelchair to be kept as small as possible. The dimensions of the seat are determined primarily by the size of the user and by the type of handicap, for which reason considerable attention has been paid to limiting the size of the chassis.

With modern wheelchairs, there have also been efforts to optimize the size and power consumption of the motors, actuators and other driving devices that are arranged to achieve the movements of the seat. Both in order to minimize the power consumption and to save space, it is therefore desirable for these driving devices not to be larger or to require more power than is required to achieve the required movements of the seat when a person is sitting on the seat.

Modern relatively small wheelchairs with seats that are adjustable around several axes have thus great advantages where use and ease of access are concerned, but also have problems when it is a question of carrying respirators and other medical equipment on the wheelchair. In particular, the limited dimensions of the chassis and large range of movement of the seat can cause problems in the positioning of the additional equipment. There is, quite simply, no space on the chassis to place the additional equipment, without this restricting the range within which the seat can move.

### PRIOR ART

Arranging a fixed shelf or the like on the chassis of a wheelchair, in order to place and attach additional equipment, such as a respirator or other medical equipment, upon this shelf, is previously known. This solution can, however, restrict the range of movement of an adjustable seat on the chassis, in particular in the case of modern electric wheelchairs with small chassis.

In order to solve this problem, it has been proposed instead to arrange a shelf or the like on the seat. The shelf, and the additional equipment carried on it, can then move with the seat. For example, by placing the shelf high up on the back of the backrest, it is possible to allow a relatively large range of movement for the seat, as the shelf with the additional equipment can then pass behind the chassis if the backrest is tilted down to a horizontal position or the whole seat is inclined backward. In order to enable the shelf and the equipment placed on the shelf to maintain a horizontal position, it has also been proposed that the shelf should be suspended on the backrest in such a way that it can pivot, like a pendulum.

While it is true that such a suspension on the backrest provides relatively good freedom of movement for the seat, it also results in a number of problems. A serious problem associated with the abovementioned known suspension of the shelf is that the weight of the shelf and of the equipment placed on the shelf must be carried by the backrest. A normal respirator, for example, can weigh around 40 kg, excluding the separate battery. The backrest must accordingly be dimensioned to be able to carry this additional load, which results in an additional cost during manufacture and a heavier and more unwieldy construction of the backrest.

In addition, and perhaps even more seriously, the driving devices that are arranged to drive the movements of the seat must be dimensioned for the additional load resulting from the shelf with the additional equipment. The driving devices must therefore be made larger and more powerful, which in turn makes it difficult or impossible to keep the overall dimensions of the wheelchair within the required limits. In addition, the increased load on the backrest means that the driving devices need to be more powerful and hence require more power, which means that the wheelchair is more expensive to manufacture and also that the period of use between charging the wheelchair's batteries is reduced.

The abovementioned problems are particularly serious if the shelf is placed high up on the backrest in order to enable the backrest to assume a horizontal position without the shelf hitting the chassis. The load resulting from the shelf and the additional equipment will then be amplified by the leverage effect that arises between the point of attachment of the shelf on the backrest and the axis around which the backrest of the seat pivots, when the backrest or the whole seat is inclined backward. Both the seat and its driving devices must therefore be dimensioned to be able to withstand this load that is amplified by the leverage effect.

In addition to the known shelf placing a load on the seat, the relatively high position of the point of attachment of the shelf means that the overall centre of gravity of the wheelchair is raised. This leads to a deterioration in handling characteristics, an increased tendency to tip over when travelling on an uneven surface and to the seat feeling unsteady in use.

Yet another disadvantage associated with the abovementioned construction is that such a shelf cannot easily be mounted on an existing wheelchair as a retrofit. The seat and driving devices of the wheelchair are, as mentioned above, usually optimally dimensioned for handling the load that arises when a user with a certain maximum weight uses the wheelchair. If a shelf of the known type described above is fitted, there is a danger that the maximum permitted load will be exceeded. Mounting such a shelf as a retrofit therefore often requires the backrest or the whole seat and its driving devices to be replaced or strengthened.

### DISCLOSURE OF INVENTION

The object of the invention is therefore to achieve a device for supporting items on a wheelchair that solves the abovementioned problems.

An object is thus to provide such a device that permits full freedom of movement for an adjustable seat mounted on the chassis of a wheelchair.

Another object is to provide such a device that enables the item that is being carried to move with the seat, without putting a significant load on the seat.

An additional object is to provide such a device by means of which the load resulting from the item that is being carried is essentially supported by the chassis.

Another object is to provide such a device that can be mounted as a retrofit without special adaptation of the wheelchair upon which it is to be mounted.

Yet another object is to provide such a device that has a simple, reliable and space-saving construction.

These objects are achieved by a device for supporting items on a wheelchair having a chassis and a seat which is movable in relation to the chassis. The device comprises an item supporting part, means for connecting the item supporting part to the seat and a load-bearing link mechanism (32) which is attachable to the chassis and which movably supports the item supporting part, for transference of load from the item supporting part to the chassis. Due to the link mechanism, the item supporting part can move in relation to the chassis and at the same time, by its connection with the seat, can be driven by the seat. The link mechanism also controls a predefined path of movement for the item supporting part. This path of movement is selected to be such that neither the item supporting part nor the item itself obstructs or prevents the movement of the seat. For example, the link mechanism enables the item supporting part to move down behind the chassis when the seat is moved to a horizontal position. As a result, the item supporting part does not come to rest in a position between the chassis and the backrest, in which position it can become wedged or prevent movement of the backrest in some other way. The link mechanism is also able to support at least a significant part of the weight of the item supporting part, so that the seat or the devices that drive the movement of the seat are not subjected to a significant load.

The device suitably comprises a balancing spring that acts on the link mechanism or directly on the item supporting part. The effect of the balancing spring is in the opposite direction to the effect of gravity on the item supporting part and helps to take the load off the seat and the connection between the seat and the item supporting part, when the item supporting part is in positions where the link mechanism is not in a state of equilibrium.

The link mechanism suitably consists of a four-link mechanism. It is thereby possible to achieve control of the movement of the item supporting part and at the same time to maintain an unchanged horizontal angle relative to the chassis during the movement. A respirator or other medical equipment that is carried by the item supporting part can thereby, for example, be held upright at a constant angle relative to the horizontal plane during the movement of the part and of the seat in relation to the chassis. Such maintaining of the angular orientation can be necessary for the function of the medical equipment and can also reduce the demands that are made on the means by which the medical equipment is attached to the item supporting part.

The device can comprise a base to which the link mechanism is attached, which base has means for being attached to the chassis. For example, it is thereby possible to achieve a modular system in which the link mechanism and the load-bearing part are common, for use with several different types of wheelchairs, while the base can be changed in order to enable the device to be mounted on different types of chassis in a simple way.

In addition, the device suitably comprises at least one resilient arm, by means of which the item supporting part can be connected to the seat. Due to the resilient nature of the connection, a more even movement of the item supporting part is achieved. At the same time, the resilient connection reduces the risk that damage will be caused to the device, the seat, the chassis or the devices that drive the movement of the seat if the movement of the item supporting part should be obstructed by a foreign object or if any part of the device should encounter an obstacle while the wheelchair is being driven.

The item supporting part can suitably comprise a shelf on which medical equipment or other items can be placed. This facilitates the transference of the load that is being carried to the chassis. Particularly if the shelf is horizontal and the link mechanism is arranged to maintain this horizontal position, the load resulting from the weight of the item is transferred directly to the chassis when the item is placed on the shelf. The item then only needs to be attached to the shelf by simple means that prevent the item from falling off the shelf, for example, if the wheelchair is being driven on an uneven or inclined surface.

In order to achieve good stability and even distribution of the load that is transferred from the device to the chassis, the device suitably comprises two link mechanisms arranged on opposite sides of the item supporting part.

The base can also comprise a second permanently attached shelf that can be used for carrying less bulky items, such as a separate battery for powering a piece of medical equipment that is being carried on the item supporting part.

The invention also relates to a wheelchair with such a device.

Further advantages and characteristics of the device and the wheelchair according to the invention will be apparent from the following description and from the patent claims.

### BRIEF DESCRIPTION OF DRAWINGS

A detailed exemplifying description of the invention is given in the following, with reference to the attached figures, in which:

FIG. 1 is a side view, with certain parts removed, of an electric wheelchair with a device according to the invention.

FIG. 2 is a perspective view of the device illustrated in FIG. 1.

FIGS. 3a and 3b are side views of the device illustrated in FIGS. 1 and 2, with FIG. 3a showing the device in a first position and 3b showing the device in a second position.

### MODES FOR CARRYING OUT THE INVENTION

Above and in the following description, directional and positional terms are used, such as forward, backward, upward, downward, lower, upper, etc. These terms refer to directions and positions in relation to a wheelchair when the device is mounted on the wheelchair. The terms are used to provide a simpler understanding of the description and are not to be regarded as restricting the invention or the extent of its protection.

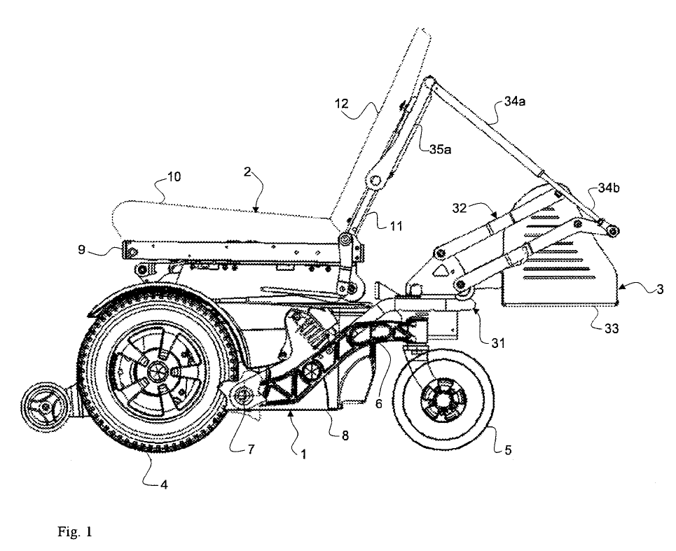

FIG. 1 shows an electric wheelchair with a device according to the invention for supporting or carrying items such as a respirator or other medical equipment. For increased clarity, FIG. 1 and the other figures show the device without the item that is being supported. The wheelchair comprises a chassis 1, a seat 2 and a device 3 according to the invention.

The chassis 1 has front driving wheels 4 and rear wheels 5. The rear wheels 5 are each arranged on rear link arms 6 in such a way that they can pivot. The two rear link arms 6 are each arranged to be able to pivot around horizontal spindles 7, that are arranged one on each side of the wheelchair. The rear link arms are also attached by means of shock absorbers 8, the upper ends of which are connected to the chassis and the lower ends of which are connected to the respective link arms.

The seat 2 comprises a seat frame 9 with a cushion 10 and a backrest frame 11 with a back cushion 12. For adjusting the position of the seat frame 9 and backrest frame 11 in relation to the chassis, the wheelchair comprises a so-called seat lift, a so-called seat tilt and a so-called backrest tilt (not shown). The seat lift is arranged to raise and lower both the seat frame and the backrest frame simultaneously in relation to the chassis in a vertical direction. The seat tilt is arranged to pivot the seat frame and the backrest frame simultaneously in relation to the chassis, around a horizontal transverse axis. The backrest tilt is arranged to tilt the backrest frame separately in relation to the seat frame and the chassis, around a horizontal transverse axis.

The seat lift, the seat tilt and also the backrest tilt comprise electrical driving devices that are operated by buttons or the like that are arranged on one of two armrests (not shown) that are attached to the backrest frame.

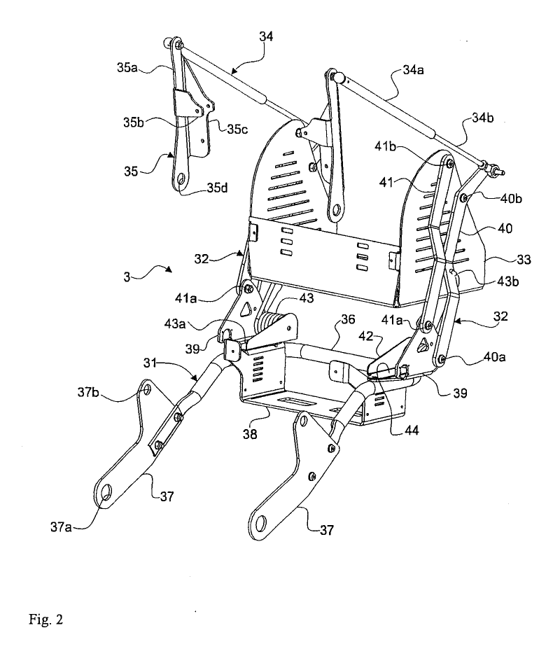

The embodiment of the device according to the invention illustrated in the figures is described below with reference to FIGS. 1 and 2. As shown most clearly by FIG. 2, the device comprises a base 31, two four-link mechanisms 32, a part 33 that carries the item, in the form of a shelf, and two arms 34 with connecting devices 35 intended to be attached to the backrest frame 11.

The base 31 comprises a generally U-shaped frame 36 of bent tubing that has fixing plates 37 at the ends of both shanks for fixing the frame 36 to the chassis 1. For this purpose, each of the fixing plates 37 has two holes 37a, 37b. The position and size of the holes 37a, 37b are designed so that the hole 37a can be threaded onto the spindle 7 and the hole 37b can receive the bolt by means of which the upper end of the shock absorber 8 is attached to the chassis. The base can thus be attached in a simple way so that it does not move in relation to the chassis, by dismantling the two rear link arms 6, positioning the holes 37a, 37b and thereafter reassembling the rear link arms 6. The base 31 also comprises a lower fixed shelf 38 that, in its mounted position, projects down a certain distance between the two rear link arms 6. The fixed shelf 38 can, for example, be used for placing extra equipment that is not too tall, such as a separate battery. Due to the low position of the shelf, there is no danger that a battery of moderate height that is placed on the shelf will prevent the movement of the seat even when the seat frame is in its reclined position and the backrest frame is folded backward to a horizontal position. A triangular mounting plate 39 is fixed on each shank of the frame 36, in the vicinity of the part of the frame that links the shanks together and that constitutes the bottom of the U-shaped frame.

Each of the two four-link mechanisms 32 comprises two link arms 40, 41. The first ends (the lower ends in FIG. 2) of the link arms 40, 41 are fixed to the respective mounting plates 39, in such a way that they can pivot, by means of first hinge pins 40a, 41a that pass through holes in the respective link arms 40, 41 and mounting plates 39. In addition, each first hinge pin 40a extends from the mounting plate 39 in the direction towards the other hinge pin into holes in fixing plates 42 in which the ends of the hinge pins that face towards each other are attached.

A torsion spring 43 of the helical spring type is arranged around each of the hinge pins 40a and extends between the mounting plates 39 and the fixing plates 42. One end 43a of the torsion spring is in contact with a supporting plate 44 arranged between the mounting plates 39 and the fixing plates 42. The other ends 43b of the springs are in engagement with their respective link arms 40. The torsion springs 43 are designed and arranged in such a way that their spring force acts on the link arms 40a in a counter-clockwise direction according to the figures.

In addition to a horizontal shelf surface (not shown), the shelf 33 comprises two opposing side walls 45 and a front wall 46. At their second ends, facing away from the first ends, the link arms 40, 41 are attached to the side walls 45, in such a way that they can pivot, by means of second hinge pins 40b, 41b that pass through holes in the link arms 40, 41 and in the side walls 45.

The two arms 34 for connecting the four-link mechanisms 32 and the shelf 33 with the backrest frame 11, are at their first ends attached to ends of the link arms 40 projecting from the side walls 45, in such a way that they can pivot. The other ends of the connecting arms 34 are attached to respective connecting device 35, in such a way that they can pivot. Each connecting device 35 comprises a side plate 35a to which a front 35b and a rear 35c support plate are attached, in such a way that the distance between the front support plate 35b and the rear support plate 35c is essentially the same as the thickness of the backrest frame 11. In addition, the side plate 35a has a through hole 35d, the diameter of which is essentially the same as the diameter of a spindle by means of which an armrest (not shown) is attached to the backrest frame 11 in such a way that it can pivot. The connecting devices 35 can thus be mounted on the backrest frame 11 in a simple way by first dismantling the armrest and thereafter arranging the connecting devices 35 on the backrest frame 11, so that the sides of the backrest frame lie between the front 35b and rear 35c support plates and the hole 37a is positioned concentrically with the spindle for the arm rest. The connecting devices 35 are thereafter attached by refitting the armrest. If necessary, the connecting devices can, in addition, be attached to the backrest frame 11 by means of screws that fit into holes intended for the purpose in the front 35b and rear 35c support plates.

In addition, the connecting arms 34 are telescopic and comprise an outer part 34a and an inner part 34b. For adjusting the position of the shelf in relation to the backrest frame, the amount by which the inner parts 34b are inserted into the outer parts 34a can be adjusted by means of a nut and bolt arrangement of a known type inside the outer parts. The outer parts 34a also contain springs, that enable the inner parts 34b to resiliently move slightly in an axial direction in relation to the outer parts 34a.

As is apparent from the description above, the device according to the invention can be mounted on a wheelchair in a very simple way. The wheelchair does not require any special modifications, for which reason the device is suitable for both fitting in the factory during manufacture of the wheelchair and as a retrofit.

As is also apparent from the description and the figures, tall items, for example a respirator or other medical equipment, can be placed on the shelf without obstructing the movement of the seat in relation to the chassis in any adjusted position of the seat. In addition, as a result of the shelf 33 maintaining a horizontal position during the movement, and as a result of the side walls 45 and the front wall 46, the equipment placed on the shelf can be secured satisfactorily in a very simple way, for example by the use of an elastic strap or the like.

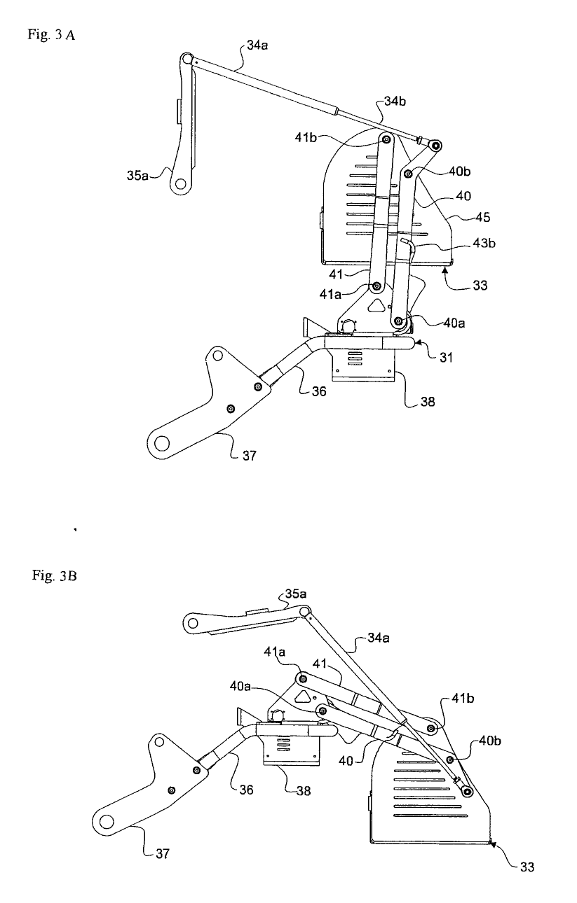

FIG. 1 shows the device when the seat frame 9 is in its lowest position and the backrest frame 11 is angled slightly backward in relation to the seat frame 9. FIG. 3a shows the device when it has assumed a different position from the position shown in FIG. 1, that corresponds to the seat frame 9 being raised and the backrest frame 11 being angled forward to a vertical position. As shown in FIG. 3a, in this case the shelf 33 has moved counter-clockwise in an arc and has assumed a highest position. FIG. 3b shows the device when it has assumed yet another position, that corresponds to the seat frame 9 being lowered again to its lowest position and the backrest frame 11 being angled backward in relation to the seat frame 9 to a horizontal position. Here, the shelf 33 has moved clockwise in an arc and assumed its lowest position behind the chassis and between the rear wheels.

Due to the two torsion springs 43 that act on the link arms 40 in a counter-clockwise direction, the movements described above can be achieved with the device in equilibrium. That is, the chassis supports essentially all the load that acts on the shelf 33, even when the shelf is slightly above the position shown in FIG. 3b, where the gravitational force that acts upon the shelf is amplified by the leverage effect that arises between the attachment points of the link arms on the shelf 33 and on the base 31.

In the example illustrated, the torsion springs 43 are dimensioned to balance the movements of the shelf when a respirator unit (not shown) that weighs approximately 40 kg is placed on the shelf. It will be recognized, however, that the torsion springs can easily be replaced by other torsion springs that have a spring constant that is adapted to balance the movement for other equipment with weights that can vary within a wide range. In addition, the torsion springs are suitably progressive, so that the spring force counteracting the gravitational force is greatest when the springs are greatly compressed, that is when the shelf is in the position shown in FIG. 3b, close to the position when the leverage effect amplifying the effect of the gravitational force is at its greatest.

An exemplifying embodiment of the device according to the invention has been described above. It should be recognized that the invention is not restricted to this description, but can be varied freely within the framework of the following claims.

1. A device for supporting items on a wheelchair having a chassis (1) and a seat (2) that is movable in relation to the chassis, that device comprising:
an item supporting part (33),
means (34, 35) for connecting the item supporting part to the seat
and a load-bearing link mechanism (32) to couple to the chassis and which movably supports the item supporting part, for transference of load from the item supporting part to the chassis.

2. The device according to claim 1, comprising at least one balancing spring (43) that is arranged to counteract the effect of gravity acting upon the item supporting part (33).

3. The device according to claim 1, wherein the load-bearing link mechanism (32) is a four-link mechanism arranged to maintain the item supporting part (33) at a substantially constant angle relative to the chassis (2) during its movement in relation to the chassis.

4. The device according to claim 1, wherein the link mechanism (32) is connected to a base (31) that comprises means (37, 37a, 37b) for fixedly attaching to the chassis (1).

5. The device according to claim 1, wherein the means for connecting the item supporting part to the seat comprises an arm (34).

6. The device according to claim 1, wherein the item supporting part (33) comprises a first shelf.

7. The device according to claim 1, comprising two load-bearing link mechanisms (32) arranged on opposite sides of the item supporting part (33).

8. The device according to claim 6, wherein the base (31) comprises a second shelf (38).

9. A wheelchair, comprising:
a chassis;
a seat carried by the chassis; and
a device for supporting items;
the device comprising:
an item supporting part;
at least one arm connecting the item supporting part to the seat; and
a load-bearing link mechanism coupling the item supporting part to the chassis, wherein the item supporting part is movably attached to the chassis for transference of load from the item supporting part to the chassis.
